(19) United States
(12) Patent Application Publication
(10) Pub. No.: US 2021/0314020 A1
(43) Pub. Date: Oct. 7, 2021

(54) SPREAD SPECTRUM COMMUNICATION IN FEMTOCELL NETWORKS, AND ASSOCIATED DEVICES, SYSTEMS, AND METHODS

(71) Applicant: Battelle Energy Alliance, LLC, Idaho Falls, ID (US)

(72) Inventors: Hussein Moradi, Idaho Falls, ID (US); Behrouz Farhang, Salt Lake City, UT (US); Arslan J. Majid, Salt Lake City, UT (US)

(21) Appl. No.: 17/249,593

(22) Filed: Mar. 5, 2021

Related U.S. Application Data
(60) Provisional application No. 62/986,480, filed on Mar. 6, 2020.

(51) Int. Cl. H04B 1/711; H04B 1/7073

(52) U.S. Cl. CPC H04B 1/711; H04B 2201/709709; H04B 1/7073

(57) ABSTRACT

Various embodiments relate to spread spectrum modulation. A device may include a processor and at least one transmitter. The device may be configured to add a cyclic prefix (CP) to each block of a number of blocks of a direct sequence spread spectrum (DSSS) signal to generate a cyclic prefix-direct sequence spread spectrum (CP-DSSS) signal. Further, the device may be configured to transmit, via a channel, the CP-DSSS signal. Associated methods and communications systems are also disclosed.

### CROSS-REFERENCE TO RELATED APPLICATION

This application claims the benefit under 35 U.S.C. § 119(e) of U.S. Provisional Patent Application Ser. No. 62/986,480, filed Mar. 6, 2020, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### FIELD

Embodiments of the present disclosure relate generally to wireless communication, and more specifically to spread spectrum modulation for communication in wireless networks. Yet more specifically, some embodiments relate to adding a cyclic prefix to a direct sequence spread spectrum signal. Further, some embodiments relate to communication systems including a primary network that includes a base station and its associated user equipment (UEs), and a secondary network of femtocells, wherein each femtocell may include a femtocell gateway (FGW) and a number of UEs.

### BACKGROUND

Spread-spectrum (SS) techniques are often used to distribute wireless transmit signals over a wider bandwidth than a minimum required transmission bandwidth. In military applications, SS transmission may be used to avoid interference and also to reduce the probability of detection or interception. In civilian applications, some forms of SS transmission may be used to allow multiple users to share the same channel or spectrum. One technique referred to as direct sequence spread spectrum (DSSS), which may be used to reduce overall signal interference, makes a transmitted signal wider in bandwidth than an information bandwidth. After despreading of the direct-sequence modulation (e.g., at a receiver), the information bandwidth is restored and interference (e.g., intentional and/or unintentional interference) may be reduced.

### BRIEF SUMMARY

One or more embodiments of the present disclosure include a device including a processor and at least one transmitter. The device may be configured to add a cyclic prefix (CP) to each block of a number of blocks of a direct sequence spread spectrum (DSSS) signal to generate a cyclic prefix-direct sequence spread spectrum (CP-DSSS) signal. The device may also be configured to transmit, via a channel, the CP-DSSS signal.

One or more other embodiments of the present disclosure include a method. The method may include adding a cyclic prefix (CP) to each block of a number of blocks of a direct sequence spread spectrum (DSSS) signal to generate a cyclic prefix-direct sequence spread spectrum (CP-DSSS) signal. The method may also include transmitting, via a device of a number of devices of a network, the CP-DSSS signal to a base station of the network.

Other embodiments may include a communication system. The communication system may include a primary network including a base station and a set of femtocells configured to share a spectrum with the primary network. Each femtocell may include a number of user equipment (UEs). Each femtocell may also include a gateway configured to communicate with each UE of the number of UEs.

### BRIEF DESCRIPTION OF THE DRAWINGS

While the specification concludes with claims particularly pointing out and distinctly claiming what are regarded as embodiments of the present disclosure, various features and advantages of embodiments of the disclosure may be more readily ascertained from the following description of example embodiments of the disclosure when read in conjunction with the accompanying drawings, in which:

FIG. 1 illustrates an example communication system, according to various embodiments of the present disclosure;

FIG. 2 depicts an example cyclic prefix added to a column vector, according to various embodiments of the present disclosure;

FIG. 3 depicts an example construction of a received signal vector after despreading, in accordance with various embodiments of the present disclosure;

FIG. 4 depicts another example construction of a received signal vector after despreading, in accordance with various embodiments of the present disclosure;

FIG. 5 depicts an example channel model, according to various embodiments of the present disclosure;

FIG. 6 illustrates an example matrix including a number of columns, according to various embodiments of the present disclosure;

FIG. 7 illustrates a multi-user network, in accordance with various embodiments of the present disclosure;

FIG. 8 illustrates another multi-user network, according to various embodiments of the present disclosure;

FIG. 9 is a flowchart of an example method of operating a communication system, in accordance with various embodiments of the present disclosure; and

FIG. 10 illustrates an example system which may be configured to operate according to one or more embodiments of the present disclosure.

### DETAILED DESCRIPTION

In the following description, reference is made to the accompanying drawings in which are shown, by way of illustration, specific embodiments in which the disclosure may be practiced. The embodiments are intended to describe aspects of the disclosure in sufficient detail to enable those skilled in the art to make, use, and otherwise practice the invention. Furthermore, specific implementations shown and described are only examples and should not be construed as the only way to implement the present disclosure unless specified otherwise herein. It will be readily apparent to one of ordinary skill in the art that the various embodiments of the present disclosure may be practiced by numerous other partitioning solutions. Other embodiments may be utilized and changes may be made to the disclosed embodiments without departing from the scope of the disclosure. The following detailed description is not to be taken in a limiting sense, and the scope of the present invention is defined only by the appended claims.

In the following description, elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths, and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A general-purpose processor may be considered a special-purpose processor while the general-purpose processor executes instructions (e.g., software code) stored on a computer-readable medium. A processor may also be implemented as a combination of computing devices, e.g., a combination of a DSP and a microprocessor, a plurality of microprocessors, one or more microprocessors in conjunction with a DSP core, or any other such configuration.

Also, it is noted that embodiments may be described in terms of a process that may be depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a function, a procedure, a subroutine, a subprogram, etc. Furthermore, the methods disclosed herein may be implemented in hardware, software, or both. If implemented in software, the functions may be stored or transmitted as one or more instructions or code on computer-readable media. Computer-readable media include both computer storage media and communication media, including any medium that facilitates transfer of a computer program from one place to another.

It should be understood that any reference to an element herein using a designation such as “first,” “second,” and so forth, does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

In the present disclosure, the term “spectrum” may refer to one or more resources for transmitting and receiving wireless data. For example, “spectrum” may refer to a frequency range that may be divided into frequency bands. As another example, “spectrum” may, additionally or alternatively, refer to a time duration that may be divided into time slots. As another example, “spectrum” may, additionally or alternatively, refer to sub-carriers that may be assigned to transmitters.

As will be appreciated, the number of wireless communication users throughout the world continues to increase. To decrease signal collisions in increasingly busy wireless communication networks, there is a continuous push to advance technologies to reduce signal power levels and/or reduce signaling overhead. Internet of things (IoT) applications, which rely heavily on wireless communication networks, may include devices, or at least clusters of devices, that are in the vicinity of one another.

IoT applications may be categorized into two classes: (i) massive machine-type communications (mMTC) and (ii) ultra-reliable low-latency communications (URLLC). In mMTC wherein a large number of devices may need to communicate, emphasis is on low-cost, scalability, and long battery lifetime. Also, in mMTC, the exchanged data packets are relatively short in terms of the number of bits transmitted. On the other hand, URLLC relates to mission-critical applications where robust and low-latency exchange of information may be needed.

Various embodiments disclosed herein relate to a signaling method including packet construction and/or despreading techniques for DSSS signals including a cyclic prefix (CP). Yet more specifically, various embodiments of the present disclosure relate to spread spectrum signaling (also referred to herein as “CP-DSSS signaling”), wherein a CP may be added to each block of a number of blocks of a direct sequence spread spectrum (DSSS) signal to generate a CP-DSSS signal. For example, a set of orthogonal vectors that are cyclically shifted versions of a spreading sequence (also referred to herein as a “root sequence”) may be modulated before adding the CP to each block of the DSSS signal to generate the CP-DSSS signal.

In various embodiments, a signaling method may allow femtocell networks (also referred to herein as “femtocells”) to serve clusters of devices (e.g., that may be located in confined and/or coverage-limited areas). According to some embodiments, a femtocell (i.e., including a cluster of devices) may co-exist within another network (e.g., a primary network; also referred to herein as a “macrocell”) while sharing spectral resources (e.g., with the primary network) (i.e., the femtocell may not need a dedicated spectrum). In other words, according to some embodiments, a DSSS signal, including a CP, may be used within a femtocell network that may co-exist with other services (e.g., 5G services) within the primary network. Yet more specifically, adding a cyclic prefix to a DSSS signal may allow for communication in the same spectrum already in use by another network (e.g., a LTE network) with minimal interference due to, for example, the nature of spread spectrum, the inherent low power transmission of user equipment within a femtocell and also the femtocell base station, and/or by using multiple antennas to add an additional layer of processing gain at the femtocell base station.

According to some embodiments (e.g., to keep network cost low), each femtocell (e.g., within a macrocell) may be controlled by a base station (e.g., a low-cost base station), which may also be referred to herein as a “femtocell gateway” (FGW). Further, according to some embodiments, a femtocell may be configured to use existing synchronization downlink signals (e.g., from an existing LTE network) to time and/or frequency synchronize a FGW and one or more other devices (e.g., UEs). Time synchronization, in particular, may be possible considering that all nodes within a femtocell and a respective FGW may be confined within a relatively small physical space (e.g., within a diameter of 100 meters).

Further, according to some embodiments, a root sequence and circularly shifted versions of the root sequence may be used to carry information symbols, and thus signal transmissions at different rates may be possible. Low data rates may allow for signal levels to be kept at a sub-noise level, which may allow for the use of a femtocell as an undelay network (e.g., similar to an ultra-wideband (UWB) system/network).

Moreover, according to some embodiments, a FGW may include multiple antennas, which may increase processing gain that may allow for transmission of underlay signals at reduced levels. Thus, interference in a network may be reduced. Further, the presence of multiple antennas at a FGW may provide for signal separation in the uplink channel, and precoding of downlink signals (i.e., for focusing the signals on the respective user antennas) may enable for construction of a multiple access network.

As will be appreciated the signaling techniques and device and/or system configurations described herein may have many wireless communication applications, including, but not limited to, IoT applications. Embodiments of the present disclosure will now be explained with reference to the accompanying drawings.

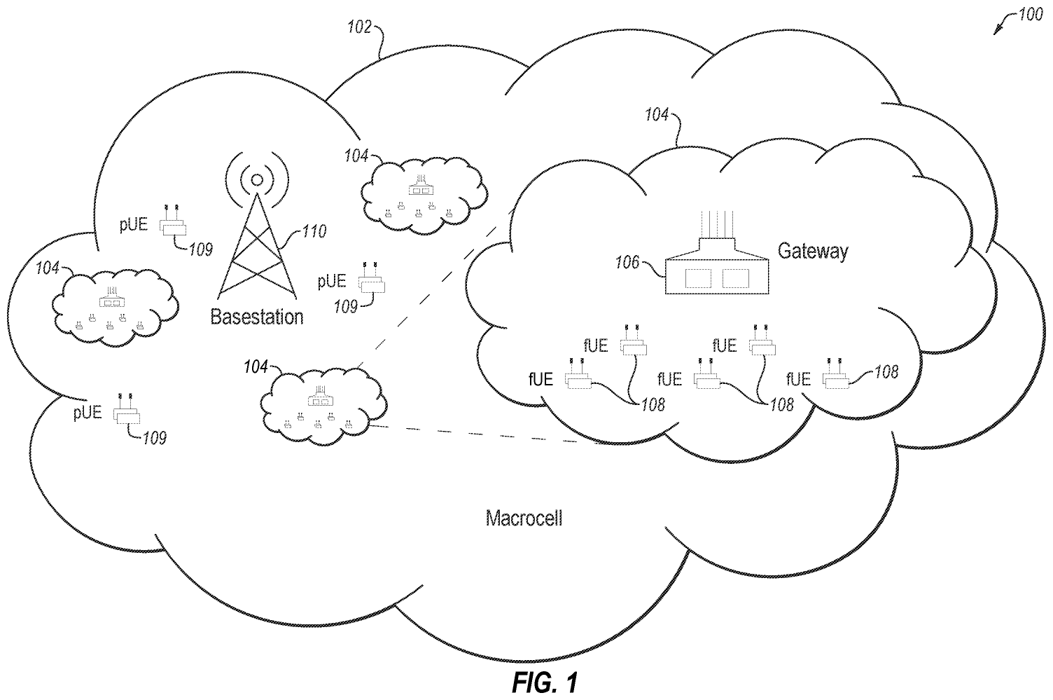

FIG. 1 illustrates an example communication system 100, in accordance with one or more embodiments of the present disclosure. Communication system 100 includes a network (also referred to herein as a “primary network”) 102 including a number of femtocells (also referred to herein as “secondary networks”) 104, wherein each femtocell 104 may include a femtocell gateway (FGW) 106 and a number of femtocell user equipment (fUEs) 108. Network 102 may further include a base station (e.g., an LTE base station) 110 and additional primary network user equipment (pUEs) 109 that may not be part of a femtocell. According to various embodiments, network 102, which may also be referred to herein as a “macrocell,” may include, for example only, an LTE network. To distinguish between UEs that belong to a femtocell and those that belong the primary network, the prefixes “f” and “p” are added; accordingly, namely fUE refers to UE within femtocell 104, and pUE refers to a UE within primary network 102.

As will be described more fully below, various devices of communication system 100 (e.g., fUEs 108, FGW 106, or other devices) may be configured for packet construction (also referred to herein as “signal modulation”) such that a CP is added to each block of a DSSS signal to generate a CP-DSSS signal. The devices may further be configured to transmit the CP-DSSS signal (e.g., via a channel) to another device (e.g., within an associated femtocell 104). Further, as also described more fully below, various devices of communication system 100 (e.g., fUEs 108, FGW 106, or other devices) may be configured to receive a CP-DSSS signal at a receiver, remove the CP from each block of the number of blocks of the CP-DSSS signal to generate a received signal vector, despread the received signal vector, and extract information from the despread received signal vector.

In accordance with various embodiments, CP-DSSS signaling may allow for data transmissions at different rates. For example, in cases wherein a required data rate is low, CP-DSSS signaling may allow for substantial processing gain, and thus, a transmitted CP-DSSS signal may remain below a noise level and, therefore, the CP-DSSS signal may co-exist as an underlay signal along with other communications signals in network 102, which may include, for example, an overlay LTE macrocell. Accordingly, the same spectrum (i.e., spectral resources) may be reused in multiple femtocells 104 that co-exist within network 102. Further, because most, if not all, devices (e.g., FGW 106 and fUEs 108) within each femtocell 104 may be positioned within a relatively small physical space (e.g., a diameter of 100 meters), the co-existence of, for example, IoT communications and an LTE network within the same spectrum/carrier may be possible.

Further reduction of signal levels within femtocell 104 may be possible by installing multiple antennas (e.g., 64, 128, 192, without limitation) at FGW 106. Multiple antennas at FGW 106 may introduce an additional processing gain that may be used to further reduce the power of a transmitted signal (e.g., within femtocell 104) to an arbitrarily low level by increasing the number of antennas at FGW 106. The presence of multiple antennas at FGW 106 may also allow for a multi-user setup where nodes (e.g., UEs 108, FGW 106, without limitation) within each femtocell 104 may transmit and receive simultaneously.

Embodiments related to CP-DSSS packet construction will now be described. For example, CP-DSSS packet construction may be performed by a device (e.g., fUE 108 of FIG. 1) a FGW (e.g., FGW 106 of FIG. 1), or other devices). According to various embodiments, each information symbol of a number of information symbols may be spread over a spreading sequence of length N, and a collection of data symbols (also referred to as a “frame”) may be transmitted (e.g., via a fUE 108 or FGW 106 of FIG. 1) simultaneously using the same spreading sequence. The spreading sequence, which may be referred to as a “root sequence”, is denoted by the following column vector:

$${z}_{0} = [ \begin{matrix}{Z}_{0} \\ {Z}_{1} \\ {Z}_{2} \\ ⋮ \\ {Z}_{N - 1}\end{matrix} ] . \qquad ( 1 )$$

Further, circularly shifted versions of column vector z₀ may be defined as:

$${z}_{1} = [ \begin{matrix}{Z}_{N 1} \\ {Z}_{0} \\ {Z}_{1} \\ ⋮ \\ {Z}_{N - 2}\end{matrix} ] , {z}_{2} = [ \begin{matrix}{Z}_{N - 2} \\ {Z}_{N - 1} \\ {Z}_{0} \\ ⋮ \\ {Z}_{N - 3}\end{matrix} ] , … , {z}_{N - 1} = [ \begin{matrix}{Z}_{1} \\ {Z}_{2} \\ {Z}_{3} \\ ⋮ \\ {Z}_{0}\end{matrix} ] . \qquad ( 2 )$$

As shown in equations (1) and (2), a bottom element of one version of the column vector is shifted to a top of a subsequent version of the column vector. More specifically, for example, in equation (1) (i.e., for version z₀), z_{N-1} is positioned at the bottom (also referred to as a “trailing edge”) of the column vector, and in equation (2) (i.e., for version z₁), z_{N-1} is positioned at the top (i.e., the beginning) of the column vector. Similarly, for version z₁, z_{N-2} is positioned at the bottom of the column vector, and for version z₂, z_{N-2} is positioned at the top (i.e., the beginning) of the column vector. Moreover, a data frame that carries a set of K data symbols s₀, s₁, . . . , s_{K-1} may be provided as:

$$x = {\sum }_{k = 0}^{K - 1} {s}_{k} {z}_{k {L}_{1}} ; \qquad ( 3 )$$

wherein

$${L}_{1} = ⌊ \frac{N}{K} ⌋ ,$$

where └⋅┌ refers to the integer part of.

It is noted that in equation (3), K symbols are used, rather than N (e.g., see equations (1) and (2)). In some embodiments, k<N (e.g., N=10K) such that the spreading of data may be diluted. In other words, increasing the value of L₁ may result in more widely spaced data symbols (e.g., after despreading) and thus, inter-symbol interference (ISI) may be reduced and a signal-to-interference ratio may be increased.

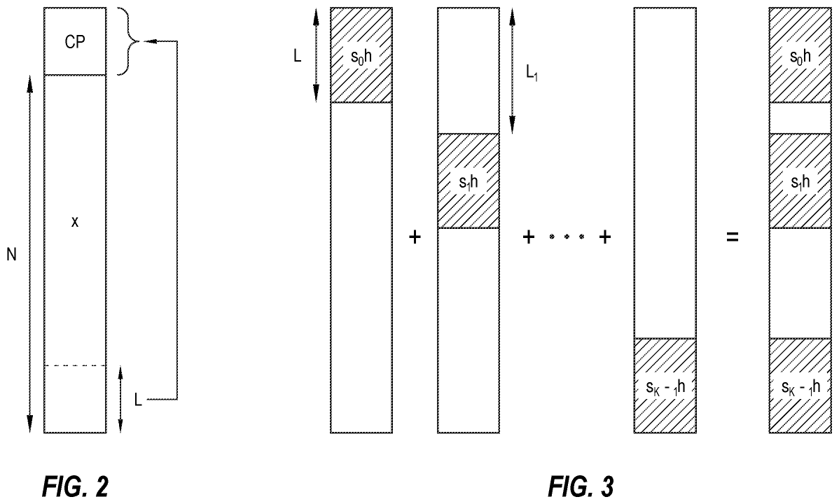

According to various embodiments, a cyclic prefix (CP) may be added to column vector x (i.e., prior to transmission of a signal). For example, FIG. 2 illustrates a CP of length L added to column vector x of length N. More specifically, as shown in FIG. 2, a sample at the bottom (“trailing edge”) of column vector x is repeated at the top (i.e., the beginning) of column vector x. The addition of CP to a DSSS signal may allow the resulting CP-DSSS signal to appear as a periodic signal (i.e., to a receiver), wherein length L should be longer than a length of a channel impulse response (i.e., to absorb the transient of the channel). The addition of a CP may result in a circular convolution of column vector x with a channel impulse response, once the CP is removed from a received signal.

After a signal (i.e., column vector x including a CP) passes through a channel (e.g., an uplink or a downlink channel) of a network (e.g., femtocell 104), the signal may be received at a receiver (e.g., FGW 106 of FIG. 1) and the CP may be removed from the received signal resulting in the following received signal vector:

$$y = ( {\sum }_{k = 0}^{K - 1} {s}_{k} {Z}_{k {L}_{1}} ) h + v ; \qquad ( 4 )$$

wherein h is the L×1 vector of the channel impulse response, Z_{kL}_{₁} is an N×L circulant matrix with a first column of z_{kL}_{₁}, and v is the vector of noise plus interference (i.e., from other communications in the network).

According to one non-limiting example, root sequence z₀ (see equation (1)) may include a root sequence of a class of Zadoff-Chu (ZC) sequences. The general formula for the class of ZC sequences of length Nis:

$${x}_{u} ( n ) = \frac{1}{\sqrt{N}} exp ( - j \frac{π u n ( n + c )}{N} ) , n = 0 , 1 , 2 , … , N - 1 ; \qquad ( 5 )$$

wherein c=0 when N is even and c=1 when N is odd. The parameter u, which is a prime integer with respect to N, is the sequence index. ZC sequences of different indices may not be orthogonal, but may exhibit a relatively small correlation.

For a given length N and a valid choice of parameter u, root-ZC sequence z₀ has elements {xᵤ(n), n=0, 1, 2, . . . , N−1} and satisfies the following properties:

$${z}_{i}^{H} {z}_{j} = \{ \begin{matrix}1 , & i = j \\ 0 , & i \neq j\end{matrix} \qquad ( 6 )$$

It is noted that zᵢ^{H}zⱼ=1 due to the normalization factor

$$\frac{1}{\sqrt{N}}$$

on the right-hand side of equation (5). Equation (6) may also be written as:

zᵢ^{H}zⱼ=δ_{i,j}; (7)

wherein the superscript H denotes Hermitian and δ_{i,j} is the Kronecker delta function.

Equation (7) is often referred to as “zero-autocorrelation property.” Besides the ZC sequence, there are many other sequences that satisfy the zero-autocorrelation property and thus any suitable sequence may be used for construction of a CP-DSSS signal. For example, as will be appreciated by a person having ordinary skill in the art, any time-domain sequence whose discrete Fourier transform (DFT) has a constant amplitude may satisfy the zero-autocorrelation property. More specifically, a time-domain sequence may be generated by executing the following code: z=ifft(exp(1i*2*pi*rand(N, 1))); wherein 1i=\sqrt{−1}, pi=π, and rand(N, 1) generates a vector of N random numbers uniformly distributed in the range 0 to 1. Hence, exp(1i*2*pi*rand (N, 1)) is vector of length N with complex entries with constant magnitude of unity. Since there are infinite choices for rand (N, 1), infinite length-N sequencies exist that satisfy the zero-autocorrelation property. In at least some embodiments, the ZC sequences may be suitable due to ZC sequences having constant magnitude in both the time-domain and in the frequency-domain.

Further, for i and j in the range of 0 to N−L and L<N, a pair of N×L circulant matrices may be defined as:

Zᵢ=[zᵢ zᵢ₊₁ . . . z_{i+L-1}]; (8)

and

Zⱼ=[zⱼ zⱼ₊₁ . . . z_{j+L-1}]; (9)

wherein equation (7) implies that when |i−j|≥L:

Zᵢ^{H}Zⱼ=0; (10)

and for i=j:

Zᵢ^{H}Zⱼ=I; (11)

wherein 0 and I are zero and identity matrices of proper size.

As will be appreciated, when |i−j|<L, Zᵢ^{H}Zⱼ is a diagonal matrix with “zeros” at its first |i−j| diagonal element and “ones” at its remaining diagonal elements.

The set of N column vectors z₀, z₁, . . . , z_{N-1} may be defined as z={z₀, z₁, . . . , z_{N-1}}. Further, an N×N circulant matrix may be defined as:

Z=[z₀ z₁ . . . z_{N-1}]; (12)

wherein Z may be an orthonormal matrix (i.e., Z^{H}Z=I), following equation (7).

Various embodiments related to signal despreading (e.g., at a receiver) will now be described. To detect data symbols and, thus, recover transmitted information from a received signal vector y, y of equation (4) may be multiplied by the Hermitian of orthonormal matrix Z to provide the following despread signal vector:

$$\tilde{y} = {Z}^{H} y = {\sum }_{k = 0}^{K - 1} {s}_{k} ( {Z}^{H} {Z}_{k {L}_{1}} ) h + \tilde{v} ; \qquad ( 13 )$$

wherein \tilde{v}=Z^{H}v.

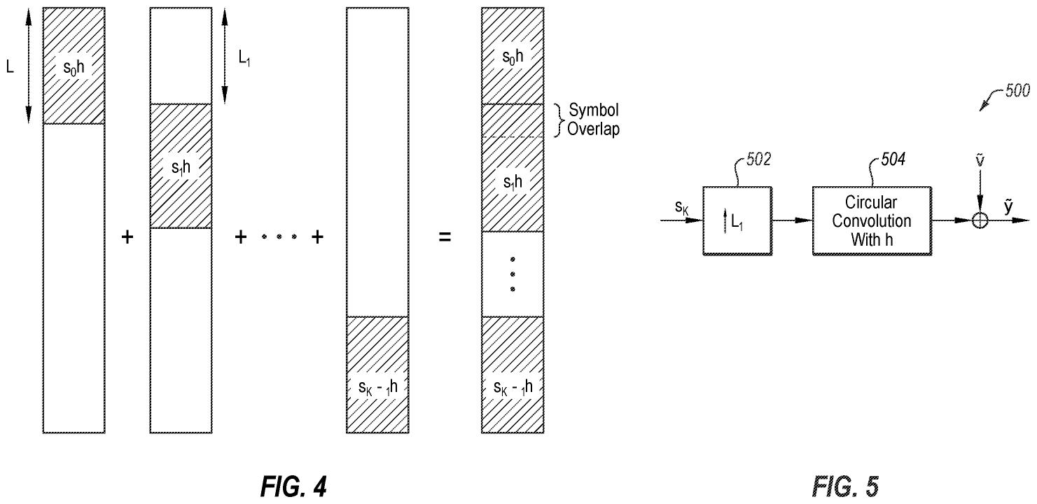

Two cases (i.e., L₁≥L and L₁<L) may be treated separately. In a first case wherein L₁≥L, the summation on the right-hand side of equation (13) may be reduced to a column vector with segments s₀h, s₁h, . . . , s_{K-1}h, each appended with L₁−L zeros, as depicted in FIG. 3. In a second case wherein L₁<L, the summation on the right-hand side of equation (13) may be reduced to a column vector in which the segments s₀h, s₁h, . . . , s_{K-1}h overlap and add together, as depicted in FIG. 4.

In the first case (i.e., where L₁≥L), the data symbols may be separated from one another, and thus, there may not be inter-symbol interference (ISI). However, in the second case (i.e., where L₁<L), overlapping of the segments s₀h, s₁h, . . . , s_{K-1}h may result in some ISI.

A system model 500 including parameter L₁ at a block 502 and a circular convolution block 504, in accordance with various embodiments, is shown in FIG. 5. Including spreading (i.e., at a transmitter) and despreading (i.e., at a receiver) as parts of a channel, system model 500 may be used for modeling a CP-DSSS channel. Further, according to various embodiments, system model 500 may also be used for detection of transmitted information.

As shown in FIG. 5, a transmitted information symbol vector s (i.e., as provided in equation (14)):

s=[s₀ sᵢ . . . s_{K-1}]^{T} (14)

is related to the received and despread signal vector \tilde{y} via the following equation:

\tilde{y}=Hs+\tilde{v}; (15)

wherein H is an N×K matrix with a first column h, appended with a sufficient number of zeros to be extended to the length of N, and each subsequent column of H is generated by circularly shifting (i.e., via circular convolution block 504) the previous column by L₁ elements.

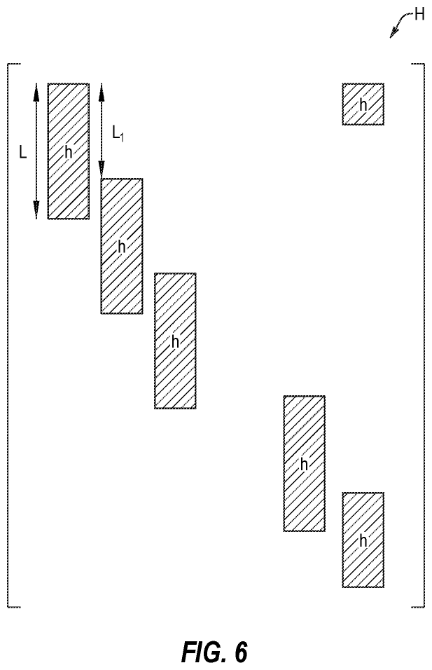

FIG. 6 depicts a matrix H including columns h, wherein L₁<L. As shown in FIG. 6, a portion of the last column h (i.e., on the right side of FIG. 6) has been truncated from an end (i.e., bottom, right side of FIG. 6) and has been copied to a top (i.e., top, right side of FIG. 6). The white space of FIG. 6 includes zeros (i.e., due to the circular convolution as shown in FIG. 5).

Certain choices of parameter L₁ may add additional properties to matrix H that may become relevant in the implementation of detectors, as described more fully below. When N is divisible by L₁, the last column of H after an L₁ circular shift becomes its first column. In this case, the matrices H^{H}H and

$${H}^{H} H + \frac{{σ}_{v}^{2}}{{σ}_{s}^{2}} I$$

that are introduced below may be circulant matrices. Circulant matrices, as well known in the art, may have certain properties that may be used for more efficient implementation of certain systems. For example, the inverse of a circulant matrix may be obtained through application of a fast Fourier transform (FFT) to a first column of the circulant matrix, inverting of the resulting elements, and then applying an inverse fast Fourier transform (IFFT) to obtain the first column of the desired matrix, which is also circulant.

In equation (15), \tilde{y} is an observation vector that may be used to estimate information symbol vector s. Known information includes H (as it is assumed that h is known) and that the elements of v are uncorrelated and have the known variance of σᵥ². A variety of detectors may be used for extraction of the information content of y. For example, one or more of the following detectors may be used:

1) A matched filter (MF) detector wherein:

ŝ=D⁻¹H^{H}\tilde{y} and D=diag(H^{H}H); (16)

2) A zero-forcing (ZF) detector wherein:

ŝ=(H^{H}H)⁻¹H^{H}\tilde{y}; (17)

3) A minimum mean square error (MMSE) detector wherein:

$$\hat{s} = {( {H}^{H} H + \frac{{σ}_{v}^{2}}{{σ}_{s}^{2}} I )}^{- 1} {H}^{H} \tilde{y} ; and \qquad ( 18 )$$

4) A soft detector that extracts log-likelihood ratio (LLR) values of the transmitted coded bits (i.e., starting with equation (15)).

It is noted that any of the above detectors and other detectors for data detection that follow linear equation (15) are applicable to detection of information that has been transmitted via CP-DSSS modulation.

Multi-user application of CP-DSSS signaling will now be described. The embodiments described above may be applicable with time division multiplexing (TDM) among different users. That is, in some embodiments, at a given time only one device (e.g., a user equipment (UE)) transmits and/or receives a CP-DSSS signal. However, embodiments of the present disclosure are not so limited, and various embodiments may provide for simultaneous transmission of CP-DSSS signals by two or more devices (e.g., fUEs or FGWs).

For example, two fUEs may transmit their respective CP-DSSS signals over the same spectrum and in a time synchronized manner (i.e., space division multiplexing (SDM)). In this example, the received signal, after despreading, may be:

$$\tilde{y} = {H}_{1} {s}_{1} + {H}_{2} {s}_{2} + \tilde{v} = [ {H}_{1} {H}_{2} ] [ \begin{matrix}{s}_{1} \\ {s}_{2}\end{matrix} ] + \tilde{v} ; \qquad ( 19 )$$

wherein s₁ and s₂ are symbol vectors transmitted by the first and second fUE, respectively, and H₁ and H₂ are the respective channel matrices. It is noted that H₁ and H₂ have similar form to matrix H shown in FIG. 6.

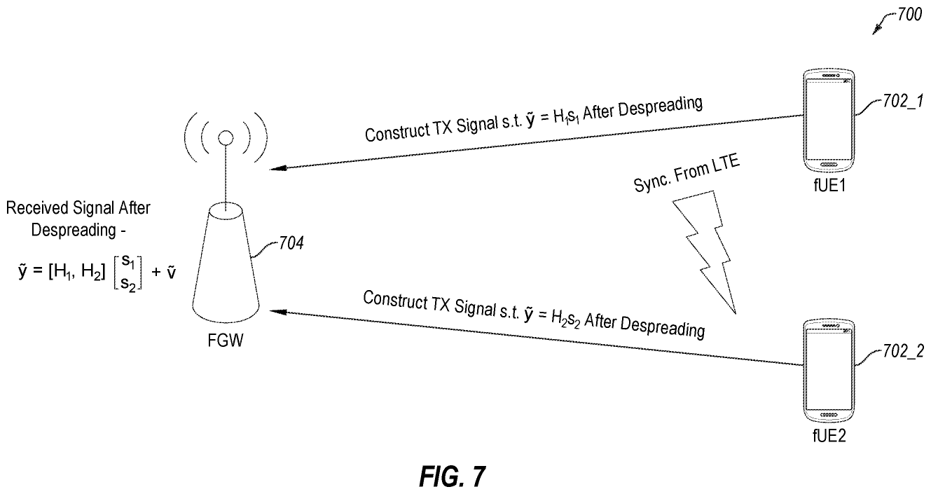

It is noted that equation (19) has the same form as equation (15) and the detectors mentioned above may be used in multi-user embodiments. However, assuming that symbol vectors s₁ and s₂ are of the same length as s in equation (15), some performance loss may occur in estimating s₁ and s₂ as compared to an estimate of s in equation (15). FIG. 7 illustrates an example multi-user CP-DSSS network 700 including two fUEs 702_1 and 702_2 transmitting uplink signals simultaneously to a FGW 704.

While equation (15) may be applicable to both uplink and downlink transmission, equation (19) may be used for uplink transmission. When more than one fUE is being served simultaneously in downlink transmissions, a precoder may be applied to separate signals that correspond to different fUEs. For instance, a zero-forcing precoder may be implemented. For example, to transmit a symbol vector s₁ from FGW 704 to fUE1 702_1, the symbol vector s₁ may be modified through a pre-coding matrix A₁, wherein A₁ may be selected such that:

H₂A₁=0. (20)

This may assure that symbol vector s₁, after traveling through the channel, may be nulled at fUE2 702_2. It is noted that the received signal at fUE1 702_1, after despreading, may be H₁A₁s₁ plus channel noise. Hence, additional constraints may be added to select A₁ such that H₁A₁ may have a proper structure for detection of the information symbols/bits. For example, maximizing the sparsity of H₁A₁ may be considered.

Similarly, to transmit a symbol vector s₂ from FGW 704 to fUE2 702_2, the symbol vector s₂ may be modified through a pre-coding matrix A₂, wherein A₂ may be selected such that:

H₁A₂=0. (21)

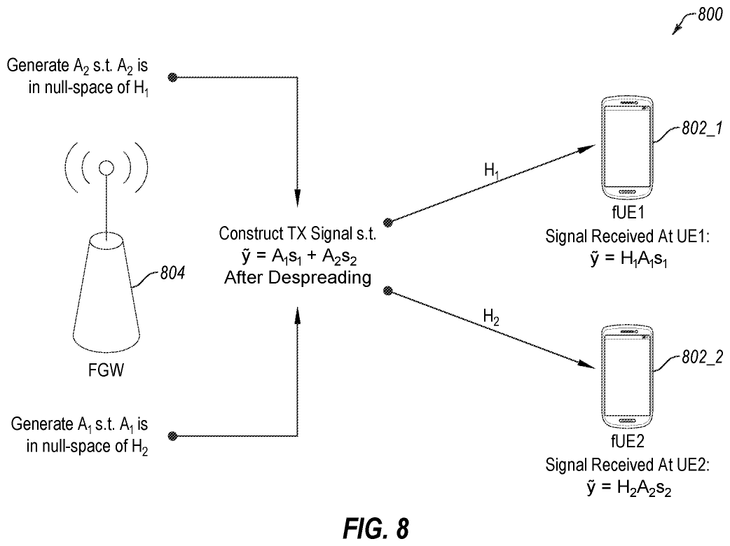

FIG. 8 illustrates another example of multi-user CP-DSSS network 800 including fUEs 802_1 and 802_2 and a FGW 804. In this embodiment, FGW 804 is transmitting downlink information simultaneously to fUE1 802_1 and fUE2 802_2.

Frequency division multiplexing (FDM) may allow for separation of multi-users when a number of UEs transmit/receive simultaneously. For example, when two fUEs transmit/receive simultaneously, the transmission band may be divided into two parts, and each part may be used by one fUE. In this example, equations (22) and (23) may be used at the receiver side, after despreading:

\tilde{y}₁=H₁s₁+\tilde{v}₁; (22)

and

\tilde{y}=H₂s₂+\tilde{v}₂. (23)

Equations (22) and (23), which are applicable to both uplink and downlink channels, are independent equations and independent detectors may be designed and used. Furthermore, generalization of these results to more than two UEs is within the scope of this disclosure.

Each of the multi-users methods (SDM and FDM) described above have advantages and disadvantages. For SDM, since power for each user is spread over the full available spectrum, the full processing gain can be realized. However, there may be some multi-user interference. For FDM, on the other hand, there may be no multi-user interference, but the processing gain is smaller. Selection of FDM versus SDM may depend on channel conditions, which may be evaluated prior to selection of either FDM or SDM.

Although various embodiments described above relate to use of a single antenna at a FGW (e.g., FGW 106 of FIG. 1), the present disclosure is not so limited, and according to various embodiments, a FGW may include multiple antennas (e.g., 64 antennas, 128 antennas, 192 antennas, or any other number of antennas). Various embodiments related to an FGM with multiple antennas will now be described.

In embodiments including multiple antennas at a FGW (e.g., FGW 106 of FIG. 1) of a femtocell (e.g., femtocell 104 of FIG. 1), for the case of uplink transmission, equation (15) may be applicable, with the following replacements:

$$\tilde{y} = \begin{matrix}{\tilde{y}}^{( 1 )} \\ {\tilde{y}}^{( 2 )} \\ ⋮ \\ ⌊ {\tilde{y}}^{( M )} ⌋\end{matrix} , H = [ \begin{matrix}{H}^{( 1 )} \\ {H}^{( 2 )} \\ ⋮ \\ {H}^{( M )}\end{matrix} ] , \tilde{v} = [ \begin{matrix}{\tilde{v}}^{( 1 )} \\ {\tilde{v}}^{( 2 )} \\ ⋮ \\ {\tilde{v}}^{( M )}\end{matrix} ] ; \qquad ( 24 )$$

wherein M is the number of antennas at the FGW, \tilde{y}⁽¹⁾ through \tilde{y}^{(M)} are the received signal vectors at the respective antennas, H⁽¹⁾ through H^{(M)} are channel gain matrices, and \tilde{v}⁽¹⁾ through \tilde{v}^{(M)} are the respective channel noise vectors.

The presence of multiple antennas at a FGW may result in a larger processing gain. Hence, transmission powers may be reduced, proportionately. This, in turn, may reduce interference that secondary users (e.g., within a femtocell) may introduce to primary users in a network (e.g., an LTE network).

Furthermore, multiple antennas at each FGW may enable multi-user CP-DSSS. Moreover, longer columns in the H matrix (see equation (24)) may provide more degrees of freedom for multi-user detectors as well as precoders that direct the signals of different users. In one example, two fUEs may send their respective data to a FGW. In this example, equation (19) may be modified to provide:

$$\tilde{y} = \begin{matrix}{H}_{1}^{( 1 )} & {H}_{2}^{( 1 )} \\ {H}_{1}^{( 2 )} & {H}_{2}^{( 2 )} \\ ⋮ & ⋮ \\ ⌊ {H}_{1}^{( M )} & {H}_{2}^{( M )} ⌋\end{matrix} [ \begin{matrix}{s}_{1} \\ {s}_{2}\end{matrix} ] + \tilde{v} ; \qquad ( 25 )$$

wherein \tilde{y} and \tilde{v} are defined in equation (24) above.

Equation (25) is similar to equation (15), and the detectors mentioned above may also be used in embodiments including multiple antennas.

On one hand, the presence of more data symbols (i.e., symbol vectors s₁ and s₂) may introduce some restrictions to a detector that may lead to some performance loss, compared to the case when only one UE transmits. On the other hand, the presence of multiple antennas may extend the length of columns of the respective channel matrix, and as a result, may provide more degrees of freedom for an improved detection of the received information.

In some embodiments, a number of antennas (i.e., parameter M) at a FGW is a large number (e.g., 128, 192, or more) or may tend to infinity. For example, in equation (25), wherein M is selected to be a large number, a “massive” multiple-input multiple-output (MIMO) femtocell scenario may exist. Assuming that the submatrices H₁⁽¹⁾ through H₁^{(M)} and H₂⁽¹⁾ through H₂^{(M)} are independent, the columns of the channel matrix shown in equation (26) may be a set of orthogonal vectors.

$$H = \begin{matrix}{H}_{1}^{( 1 )} & {H}_{2}^{( 1 )} \\ {H}_{1}^{( 2 )} & {H}_{2}^{( 2 )} \\ ⋮ & ⋮ \\ ⌊ {H}_{1}^{( M )} & {H}_{2}^{( M )} ⌋\end{matrix} . \qquad ( 26 )$$

In this example, a matched filter (MF) detector (e.g., see equation (16)) may be used. In this example, the detector may use (e.g., include) a set of time reversal matched filters. In some embodiments, a MF detector may be used in a massive MIMO scenario. In this example:

$$\hat{s} = {D}^{- 1} {H}^{H} \tilde{y} = {( diag ( {H}^{H} H ) )}^{- 1} ( ( {H}^{H} H ) [ \begin{matrix}{s}_{1} \\ {s}_{2}\end{matrix} ] + {H}^{H} \tilde{v} ) . \qquad ( 27 )$$

When parameter M is very large (e.g., tends to infinity), coefficient matrix (H^{H}H) may approximately be a diagonal matrix. With a very large number of antennas at a FGW, even in a low SNR scenario, § may provide an accurate estimate of symbol vectors s₁ and s₂.

In some embodiments wherein the number of antennas at an FGW is large (e.g., 64 or less), but not sufficiently large for coefficient matrix (H^{H}H) to be sufficiently diagonal, a MF detector may not perform sufficiently well. Under this condition, other detectors, such as ZF and/or MMSE detectors may be used. As noted above, the present disclosure in not limited to any specific detector, and a variety of the detectors disclosed herein and other detectors may be used in CP-DSSS modulation.

For downlink transmission, the embodiments described above using FDM in multi-user CP-DSSS and/or SDM in multi-user CP-DSSS may be extended to embodiments including multiple antennas at the FGW. Further, other known and suitable precoding options for MIMO and massive MIMO systems are also within the scope of this disclosure.

Embodiments relating to per-tone signal processing will now be described. According to at least some embodiments, the presence of a CP in a CP-DSSS signal may enable some (e.g., a majority) of signal processing tasks to be performed in the frequency domain in a per-tone manner. This may simplify signal detection at a receiver.

As will be appreciated by a person having ordinary skill in the art, the presence of CP may cause each CD-DSSS signal frame to appear periodic to a channel. Moreover, each transmit signal frame x (i.e., before the addition of CP) may be expressed by its DFT (denoted by xf). It is noted that the elements of xf are effectively the Fourier series coefficient of the underlying periodic signal (i.e., the periodic signal generated by periodic repetition of the frame vector x). In addition, the received signal vector y, after removing the CP, has the DFT of yf, and the individual elements of yf may be determined by multiplying the individual elements of xf with the elements of DFT of the channel impulse response. Accordingly, the channel distortion may be removed from the received frequency domain signal yf by dividing elements of the received frequency domain signal yf with the elements of the DFT of the channel impulse response. Also, matched filtering with the channel impulse response may be performed by element-wise multiplication of yf with the DFT of the channel impulse response. These ideas may be extended to more complex signal detections, for instance, when signals from multiple antennas are combined to achieve some optimality for information recovery.

As described herein, various embodiments relate to devices, systems, and methods for spread spectrum signaling. Various embodiments may include use of CP-DSSS signaling in a femtocell that may co-exist within a network (e.g., an LTE network), while using the same spectrum. In various embodiments, a CP-DSSS signal may have the same signal frame length to that of OFDM symbols in the network. Further, as described herein, a CP may be added to each frame (e.g., similar to a CP being added to each OFDM symbol frame). By doing so, downlink synchronization signals (e.g., LTE downlink synchronization signals) may be used to synchronize one or more fUEs and a FGW within a network (e.g., femtocell) (e.g., to allow for efficient operation of the network).

Further, by using a root sequence (e.g., a Zadoff-Chu (ZC) root sequence) and circularly shifted versions of the root sequence to carry information symbols, signal transmissions at different rates may be possible. Keeping data rates low (e.g., sufficient for massive machine type communications which the femtocells may be designed for), may allow signal levels to be kept at a sub-noise level, which may allow for the use of a femtocell as an undelay network, somewhat similar to an ultra-wideband (UWB) system/network.

Moreover, multiple antennas at a FGW of a femtocell may provide additional processing gain that in turn may allow for transmission of underlay signals at a reduced level, and thus interference in a network may be reduced. Further, the presence of multiple antennas at a FGW may provide for signal separation at the FGW in the uplink channel, and precoding of downlink signals (i.e., for focusing the signals on the respective user antennas) may enable for construction of a multiple access network.

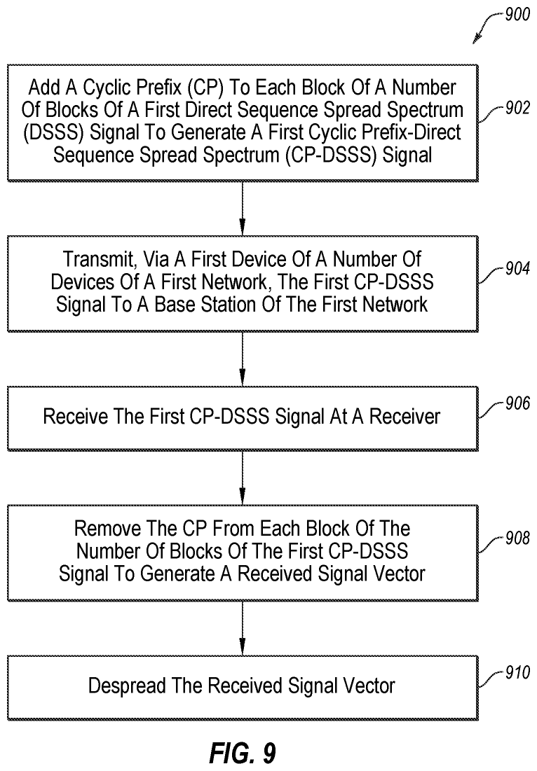

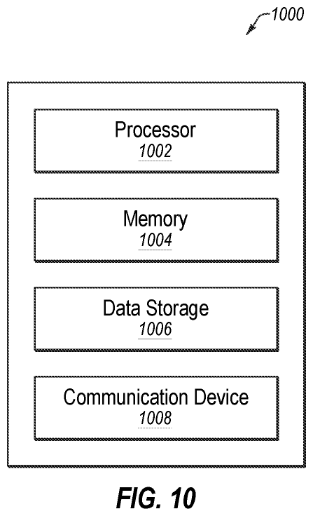

FIG. 9 is a flowchart of an example method 900 of operating a communication system, in accordance with various embodiments of the disclosure. Method 900 may be arranged in accordance with at least one embodiment described in the present disclosure. Method 900 may be performed, in some embodiments, by a device or system, such as system 100 of FIG. 1, system model 500 of FIG. 5, network 700 of FIG. 7, network 800 of FIG. 8, a system 1000 of FIG. 10, or another device or system. Although illustrated as discrete blocks, various blocks may be divided into additional blocks, combined into fewer blocks, or eliminated, depending on the desired implementation.

Method 900 may begin at block 902, wherein a cyclic prefix (CP) may be added to each block of a number of blocks of a first direct sequence spread spectrum (DSSS) signal to generate a first CP-DSSS signal, and method 900 may proceed to block 904. For example, a device (e.g., fUE 108 of femtocell 104 of FIG. 1) may add the CP to each block of the number of blocks of the first DSSS signal to generate the first CP-DSSS signal. More specifically, for example, a CP may be added to each block of the number of blocks via modulating a set of vectors (e.g., orthogonal vectors) that are cyclically shifted versions of a root sequence (e.g., a Zadoff-Chu root sequence).

At block 904, the first CP-DSSS signal may be transmitted to a base station, and method 900 may proceed to block 906. For example, the device (e.g., fUE 108 of FIG. 1) of a network (e.g., femtocell 104 of FIG. 1) may transmit the first CP-DSSS signal to a base station (e.g., FGW 106 of FIG. 1) of the network.

At block 906, the first CP-DSSS signal may be received at a receiver, and method 900 may proceed to block 908. More specifically, for example, the first CP-DSSS signal may be received at the base station (e.g., FGW 106 of FIG. 1) of the network.

At block 908, the CP from each block of the number of blocks of the first CP-DSSS signal may be removed to generate a received signal vector, and method 900 may proceed to block 910. For example, the receiver (e.g., FGW 106 of FIG. 1) may remove the CP from each block of the number of blocks of the first CP-DSSS signal to generate the received signal vector.

At block 910, the received signal vector may be despread. For example, the receiver (e.g., FGW 106 of FIG. 1) may despread the received signal vector via a Hermitian cyclically shifted versions of a root sequence (e.g., a Zadoff-Chu root sequence).

Modifications, additions, or omissions may be made to method 900 without departing from the scope of the present disclosure. For example, the operations of method 900 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment. For example, in various embodiments, method 900 may include one or more acts wherein signaling between devices of a femtocell (e.g., a FGW and at least some of a number of fUEs) are synchronized via downlink synchronization of a long-term evolution (LTE) network including the first network. As another example, in various embodiments, method 900 may include one or more acts wherein information is extracted from the despread received signal vector via one of a number of detectors (e.g., a matched filer (MF) detector, a zero-forcing (ZF) detector, a minimum mean square (MMSE) detector, or a detector configured to extract log-likelihood ratio (LLR) values).

In another example, method 900 may include one or more acts including multi-user communication. More specifically, for example, method 900 may include one or more acts wherein downlink information including one or more CP-DSSS signals is transmitted from a FGW to multiple fUEs. In yet another example, method 900 may include one or more acts wherein uplink information including one or more CP-DSSS signals is transmitted from multiple fUEs to a FGW.

FIG. 10 is a block diagram of an example system 1000, which may be configured according to at least one embodiment described in the present disclosure. As illustrated in FIG. 10, system 1000 may include a processor 1002, a memory 1004, a data storage 1006, and a communication unit 1008. One or more of fUE 108 and FGW 106 (see FIG. 1), or parts thereof, may be or include an instance of system 1000.

Generally, processor 1002 may include any suitable special-purpose or general-purpose computer, computing entity, or processing device including various computer hardware or software modules and may be configured to execute instructions stored on any applicable computer-readable storage media. For example, processor 1002 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 10, it is understood that processor 1002 may include any number of processors. In some embodiments, processor 1002 may interpret and/or execute program instructions and/or process data stored in memory 1004, data storage 1006, or memory 1004 and data storage 1006. In some embodiments, processor 1002 may fetch program instructions from data storage 1006 and load the program instructions in memory 1004. After the program instructions are loaded into memory 1004, processor 1002 may execute the program instructions, such as instructions to perform one or more operations described in the present disclosure.

Memory 1004 and data storage 1006 may include computer-readable storage media or one or more computer-readable storage mediums for carrying or having computer-executable instructions or data structures stored thereon. Such computer-readable storage media may be any available media that may be accessed by a general-purpose or special-purpose computer, such as processor 1002. By way of example, and not limitation, such computer-readable storage media may include non-transitory computer-readable storage media including Random Access Memory (RAM), Read-Only Memory (ROM), Electrically Erasable Programmable Read-Only Memory (EEPROM), magnetic disk storage or other magnetic storage devices, flash memory devices (e.g., solid state memory devices), or any other storage medium which may be used to carry or store program code in the form of computer-executable instructions or data structures and which may be accessed by a general-purpose or special-purpose computer. Computer-executable instructions may include, for example, instructions and data configured to cause processor 1002 to perform a certain operation or group of operations e.g., related to embodiments disclosed herein.

Communication unit 1008 may be configured to provide for communications with other devices (e.g., fUEs or a FGW). For example, communication unit 1008 may be configured to transmit to and receive signals according to various embodiments disclosed herein. Communication unit 1008 may include suitable components for communications including, as non-limiting examples, a radio, one or more antennas, one or more encoders and decoders, and/or a power supply.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the invention as hereinafter claimed, including legal equivalents thereof. In addition, features from one embodiment may be combined with features of another embodiment while still being encompassed within the scope of the invention. Further, embodiments of the disclosure have utility with different and various detector types and configurations.

What is claimed is:

1. A device including a processor and at least one transmitter, the device configured to:
add a cyclic prefix (CP) to each block of a number of blocks of a direct sequence spread spectrum (DSSS) signal to generate a cyclic prefix-direct sequence spread spectrum (CP-DSSS) signal; and
transmit, via a channel, the CP-DSSS signal.

2. The device of claim 1, wherein the device is configured to modulate a set of orthogonal vectors that are cyclically shifted versions of a root sequence to add the CP to each block of the number of blocks of the DSSS signal.

3. The device of claim 1, wherein the device is configured to transmit the CP-DSSS signal, via the channel, to a femtocell gateway (FGW) within a first network.

4. The device of claim 3, wherein the device is further configured to at least one of:
synchronize signaling with the FGW via downlink synchronization of a long-term evolution (LTE) network including the first network; and
share spectrum resources with the LTE network.

5. The device of claim 1, wherein the device is further configured to transmit the CP-DSSS signal via the channel at a power level less than a noise floor of the channel.

6. The device of claim 1, wherein the device includes a user equipment (UE) of a femtocell.

7. A method, comprising:
adding a cyclic prefix (CP) to each block of a number of blocks of a first direct sequence spread spectrum (DSSS) signal to generate a first cyclic prefix-direct sequence spread spectrum (CP-DSSS) signal; and
transmitting, via a first device of a number of devices of a first network, the first CP-DSSS signal to a base station of the first network.

8. The method of claim 7, further comprising synchronizing signaling between the base station and at least some of the number of devices via downlink synchronization of a long-term evolution (LTE) network including the first network.

9. The method of claim 7, wherein adding the CP comprises modulating a set of orthogonal vectors that are cyclically shifted versions of a root sequence.

10. The method of claim 9, further comprising:
receiving the first CP-DSSS signal at a receiver;
removing, via the receiver, the CP from each block of the number of blocks of the first CP-DSSS signal to generate a received signal vector; and
despreading the received signal vector via a Hermitian of the cyclically shifted versions of the root sequence.

11. The method of claim 10, wherein receiving the first CP-DSSS signal comprises receiving the first CP-DSSS signal via a plurality of antennas of the receiver.

12. The method of claim 10, further comprising extracting information from the despread received signal vector via one of a matched filer (MF) detector, a zero-forcing (ZF) detector, a minimum mean square (MMSE) detector, and a detector configured to extract log-likelihood ratio (LLR) values.

13. The method of claim 7, further comprising:
adding another cyclic prefix (CP) to each block of another number of blocks of another DSSS signal to generate a second CP-DSSS signal; and
transmitting, via a second device of the number of devices of the first network, the second CP-DSSS signal to the base station of the first network;
wherein the first CP-DSSS signal and the second CP-DSSS signal are transmitted to the base station substantially simultaneously via one of space division multiplexing and frequency division multiplexing.

14. The method of claim 7, further comprising transmitting, substantially simultaneously, downlink information from the base station to a plurality of devices of the number of devices via one of space division multiplexing and frequency division multiplexing.

15. A communication system, comprising:
a primary network including:
a base station; and
a femtocell configured to share a spectrum with the primary network such that at least some communications in the primary network and the femtocell occur substantially simultaneously on the same spectrum, the femtocell including:
a number of user equipment (UEs); and
a gateway configured to communicate with each UE of the number of UEs.

16. The communication system of claim 15, wherein the primary network comprises a long-term evolution (LTE) network.

17. The communication system of claim 15, wherein the gateway comprises a femtocell gateway including multiple antennas.

18. The communication system of claim 17, wherein the femtocell gateway includes a 32 or more antennas and wherein at least one UE of the number of UEs is configured to transmit a CP-DSSS signal via the channel at a power level less than a noise floor of the channel.

19. The communication system of claim 15, wherein at least one UE of the number of UEs is configured to:
add a cyclic prefix (CP) to each block of a number of blocks of a direct sequence spread spectrum (DSSS) signal to generate a CP-DSSS signal; and
transmit the CP-DSSS signal within the femtocell.

20. The communication system of claim 19, wherein the gateway is configured to:
receive the CP-DSSS signal; and
demodulate the CP-DSSS signal via a Hermitian of cyclically shifted versions of a root sequence.

21. The communication system of claim 15, wherein at least one UE of the number of UEs is configured to synchronize in time and frequency with the gateway via a downlink signal from the base station.

22. The communication system of claim 15, wherein at least one UE of the number of UEs and the gateway are configured to process signals in the frequency domain in a per-tone manner.
